(19) United States
(12) Patent Application Publication
(10) Pub. No.: US 2012/0138177 A1
(43) Pub. Date: Jun. 7, 2012

(54) Mixer Faucet

(76) Inventor: Ruifu Wang, Fu Yong Township (CN)

(21) Appl. No.: 12/960,988

(22) Filed: Dec. 6, 2010

(51) Int. Cl. F16K 11/00

(52) U.S. Cl. 137/606

(57) ABSTRACT

A mixer faucet includes a faucet fixed to a fixing board in a wall and a temperature control valve is connected to the temperature control valve seat. Two check valves are connected to the check valve seats of the cold and hot water paths of the faucet. An indication board is connected to the faucet and seals an installation hole in the wall. The indication board has two access holes which are located corresponding to the check valves. The check valve seats each have a reception recess and the two respective reception recesses are oriented inclinedly and outward. A water inlet is defined between each of the reception recesses and an installation recess of each of the temperature control valve seats. The faucet can be made by way of forging and machined after being forged. The maintenance to the check valves is convenient.

### FIELD OF THE INVENTION

The present invention relates to a faucet, and more particularly, to a mixer faucet for convenience of maintenance and fabrication.

### BACKGROUND OF THE INVENTION

A conventional mixer faucet is shown in FIG. 1 and generally includes a faucet 10 fixed to a fixing board in the wall and includes a cold water path 11, a hot water path 12, two mixing paths 13 and a temperature control valve seat 14. The cold and hot water paths 11, 12 each have a check valve seat 15 connected thereto and two check valves are connected to the check valve seats 15 so as to avoid cold and hot water from flowing backward. A temperature control valve is rotatably connected to the temperature control valve seat 14 so as to control the volume of the cold and hot water entering the mixing paths 13 and the temperature of the mixture of the cold and hot water flowing out from the faucet. An indication board is connected on the wall and contacts the faucet 10, and an access hole is defined in the indication board and located corresponding to the check valve so that the check valve can be checked and maintained via the access hole.

However, the conventional mixer faucet 10 has the following shortcomings:

1. There is a fixed distance between the check valve seat 15 and the access hole 151 so that the repairer has to use special tools to access the check valve. Nevertheless, interference exists between the tools, the indication board and especially the inside of the access hole, and this results significant inconvenience.

2. The water inlet path 16 located between the installation recess 141 of the temperature control valve seat 14 and the installation recess 151 of the check valve cannot be machined. Even the tilt machining to machine the water inlet path 16, the miller or drill is interfered by the outside of the check valve seat 15. Therefore, the conventional mixer faucet cannot be made by way of forging together with conventional machining methods. Casting is the only option to make the conventional mixer faucet, but this method can only have rough surfaces on the mixer faucet and low value.

3. The conventional mixer faucet does not have anti-leak design so that when the temperature control valve leaks, the water directly enters into the wall and is difficult to be found. In other words, the problem is found when significant damage to the wall is made.

4. The indication board does not have fixing holes so that the indication board is difficult to be installed properly.

5. There are no pads for the faucet 10 so that the gap between the cold and hot water paths 11, 12 and the connection portions 111, 121 of the two mixing paths 13 is too small to easily maintain or check the connection portions 111, 121 when leakage happens.

The present invention intends to provide a mixer faucet which improves all of the shortcomings of the conventional mixer faucet.

### SUMMARY OF THE INVENTION

The present invention relates to a mixer faucet and comprises a faucet fixed to a fixing board in a wall and includes a cold water path, a hot water path, two mixing paths and a temperature control valve seat. The cold and hot water paths each have a check valve seat connected thereto and two check valves are connected to the check valve seats. A temperature control valve is connected to the temperature control valve seat. An indication board is connected to the faucet and seals an installation hole in the wall. The indication board includes two access holes which are located corresponding to the check valves, and a central hole is defined through the indication board and the temperature control valve extends through the central hole. The check valve seats each have a reception recess and the two respective reception recesses are oriented inclinedly and outward. A water inlet is defined between each of the reception recesses and an installation recess of each of the temperature control valve seats. Each of the water inlets includes a vertical path and an inclined path. The vertical path extends downward from an inner end of the installation recess of the temperature control valve seats. The inclined path extends inclinedly and downward from an inside of the installation recess of the check valve seat and communicates with the vertical path.

The temperature control valve seats of the faucet includes a positioning groove defined in an outside thereof and a seal ring is engaged with the positioning groove. A sleeve is threadedly mounted to the temperature control valve seats so as to press the temperature control valve on the temperature control valve seats. An inside of the sleeve is in contact with the seal ring.

The faucet includes at least two pads on an underside thereof so as to contact the surface of the fixing board. The at least two pads have a height which defines an operation room between the connection portions of the cold and hot water paths, the connection portions of the mixing paths and the surface of the fixing board.

An installation flange is located between outside of the faucet and respective tops of the temperature control valve seats. The installation flange includes multiple first fixing holes. Multiple support tubes extend from an inner end of the indication board and each support tube has a passage defined therein. Multiple bolts each extend through the passage of the support tube and are connected with the first fixing holes to fix the indication board to the installation flange.

The installation flange includes multiple second fixing holes and bolts extend through the second fixing holes and are fixed to the fixing board to fix the faucet to the fixing board.

Thanks to the inclined and outward installation recesses of the check valve seats, the installation of the check valves are substantially in alignment with the access holes of the indication board, so that the maintenance and installation are easy and convenient for having sufficient room.

The water inlet is defined between each of the reception recesses and an installation recess of each of the temperature control valve seats, this arrangement provides sufficient room for machining so that after the faucet is made by way of forging, machining to the installation flange can be made.

The sealing between the seal ring and the sleeve prevents water that leaks from the temperature control valve does not enter into the wall and can be visible on the outside of the wall by the users so that maintenance is proceeded immediately.

The pads on the underside of the faucet provides an operation room between the connection portions of the cold and hot water paths, the connection portions of the mixing paths and the surface of the fixing board. The operation room allows the repairers to access the parts.

The first and second fixing holes in the installation flange make the connection between the faucet and the fixing board, and the connection between the indication board and the faucet easy and convenient. The installation flange is in flush with the tops of the check valve seats so that a sufficient distance is defined between the installation flange and the fixing board. Therefore, when changing the indication board, especially when the support tubes are too short, longer bolts can easily lock the indication board without worry about interference between the distal ends of the bolts and the fixing board.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a partial cross sectional view of a conventional mixer faucet;

FIG. 2 is a perspective view to show the mixer faucet of the present invention;

FIG. 3 is another perspective view to show the mixer faucet of the present invention;

FIG. 4 is a cross sectional view taken along line A-A in FIG. 2;

FIG. 5 is an exploded view to show the mixer faucet of the present invention;

FIG. 6 is a side cross sectional view of the mixer faucet of the present invention;

FIG. 7 is a top view of the mixer faucet of the present invention;

FIG. 8 is a cross sectional view taken along ling B-B in FIG. 7, the faucet is connected to the fixing board;

FIG. 9 is a top view of the faucet and the indication board;

FIG. 10 is a cross sectional view taken along line C-C in FIG. 9, and

FIG. 11 is a cross sectional view to show the mixer faucet of the present invention.

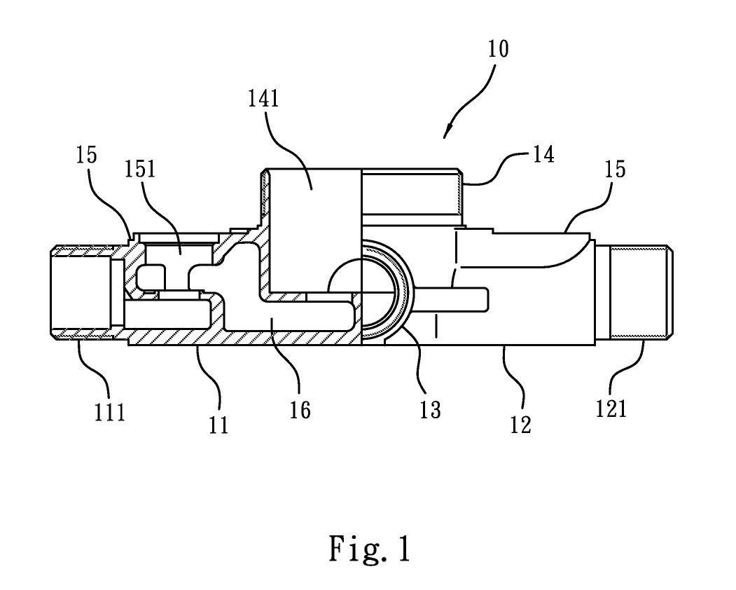

### DETAILED DESCRIPTION OF THE PREFERRED EMBODIMENT

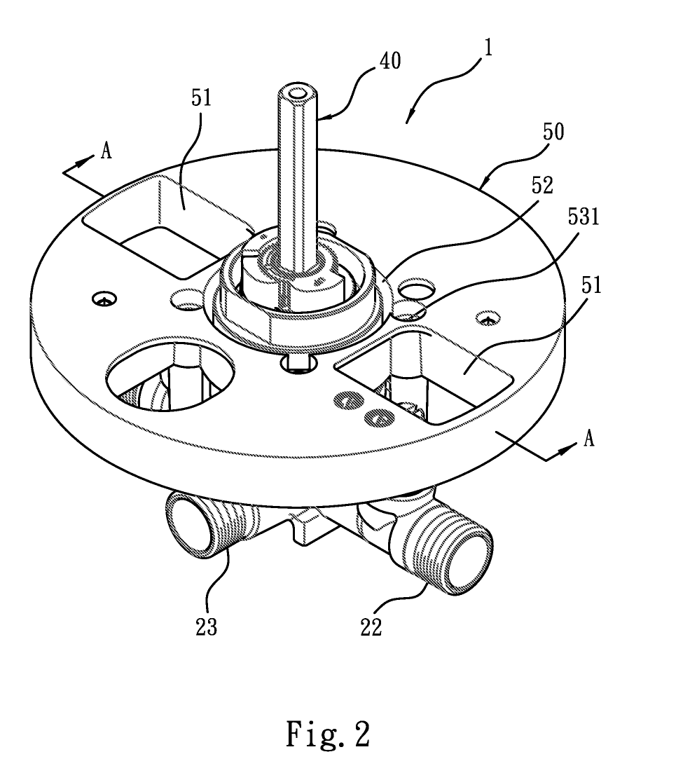

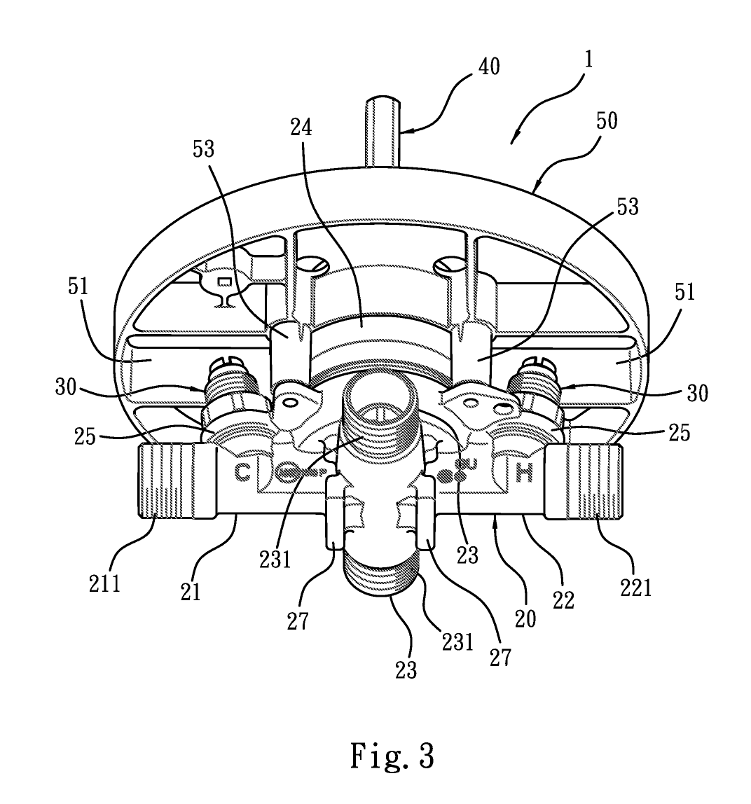

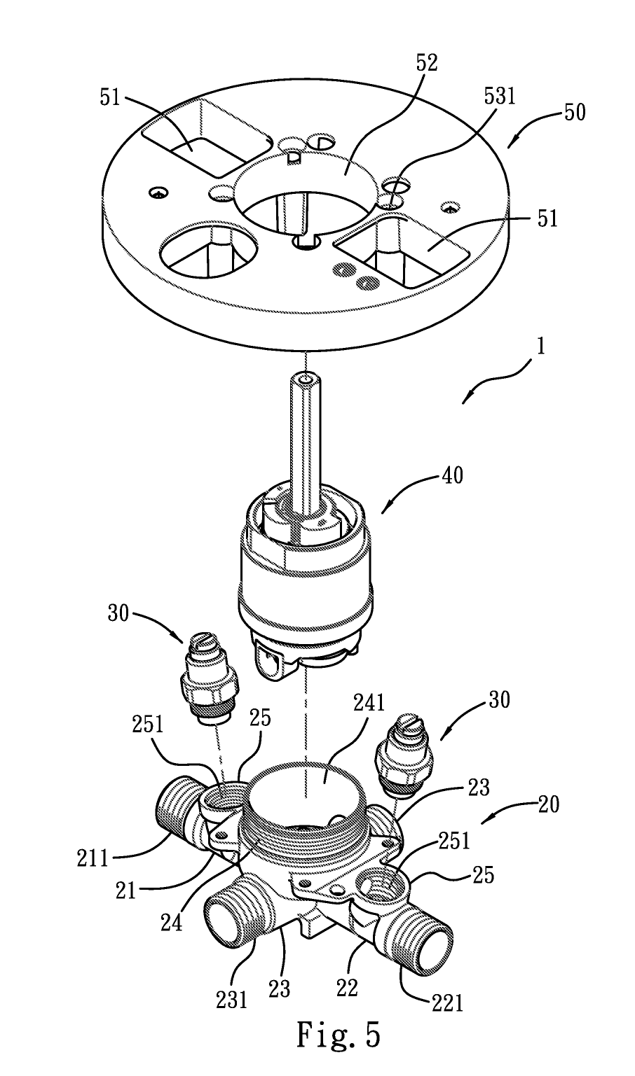

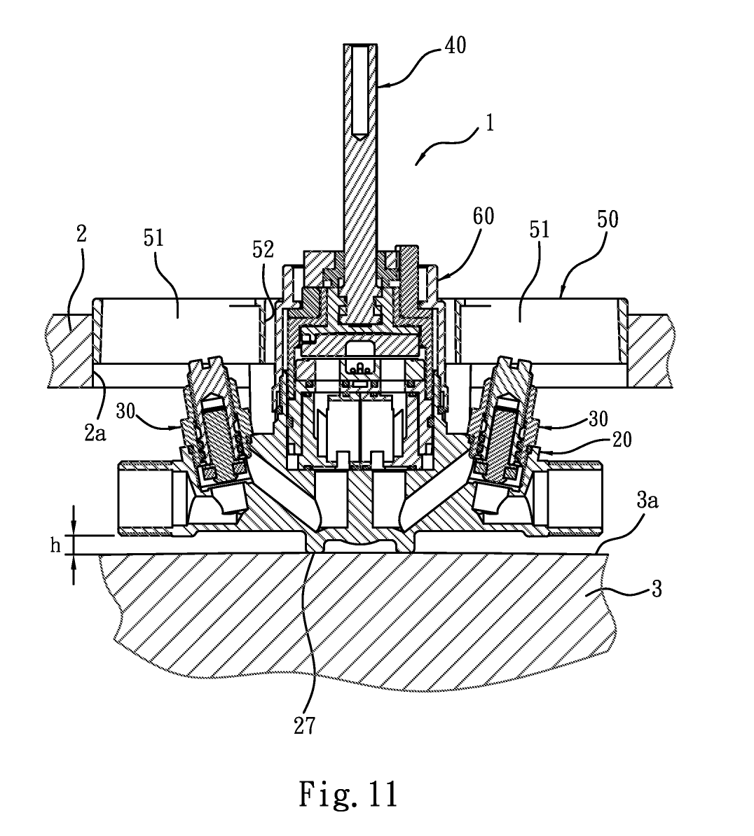

Referring to FIGS. 2 to 5, the mixer faucet 1 of the present invention comprises a faucet 20 which is fixed to a fixing board 3 in a wall 2 and has a cold water path 21, a hot water path 22, two mixing paths 23 and a temperature control valve seat 24. The cold and hot water paths 11, 12 each have a check valve seat 25 connected thereto and two check valves 30 are connected to the check valve seats 25. A temperature control valve 40 is connected to the temperature control valve seat 24 so as to adjust the temperature of the mixture of the water flowing out from the faucet 20. An indication board 50 is connected to the faucet 20 and seals an installation hole 2a in the wall 2 as shown in FIG. 11. The indication board 50 further has two access holes 51 which are located corresponding to the check valves 30. A central hole 52 is defined through the indication board 50 and the temperature control valve 40 extends through the central hole 52.

The inventive portion of the present invention is that the check valve seats 25 each have a reception recess 251 and the two respective reception recesses 251 are oriented inclinedly and outward. A water inlet 26 is defined between each of the reception recesses 251 and an installation recess 241 of each of the temperature control valve seats 24. Each of the water inlets 26 includes a vertical path 261 and an inclined path 262, wherein the vertical path 261 extends downward from an inner end 242 of the installation recess 241 of the temperature control valve seats 24, and the inclined path 262 extends inclinedly and downward from an inside of the installation recess 251 of the check valve seat 26 and communicates with the vertical path 261.

By the inclined and outward installation recesses 251 of the check valve seats 25, the installation of the check valves 30 are substantially in alignment with the access holes 51 of the indication board 50. Therefore, the maintenance and installation of the check valves 30 are easy and convenient for having sufficient room and the tools for maintaining the check valves 30 are not interfered by the indication board 50, especially by the inside of the access holes 51.

The water inlets 26 each are composed of a vertical path 261 and the inclined path 262, so that the tools such as the milling tools or the drills can easily mill or drill the vertical path 261 via the installation recess 241 of the temperature control valve seat 24, and the milling tools or the drills can easily mill or drill the inclined path 262 via the installation recess 251 of the check valve seat 25. The faucet 20 can be made by way of forging in stead of casting, and the faucet 20 is then machined to have smooth outer surface.

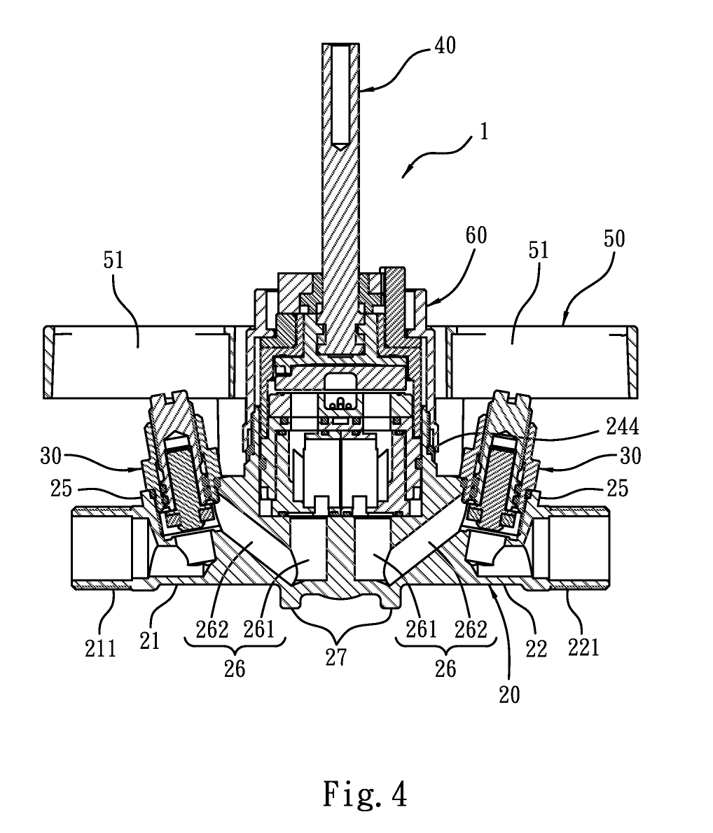

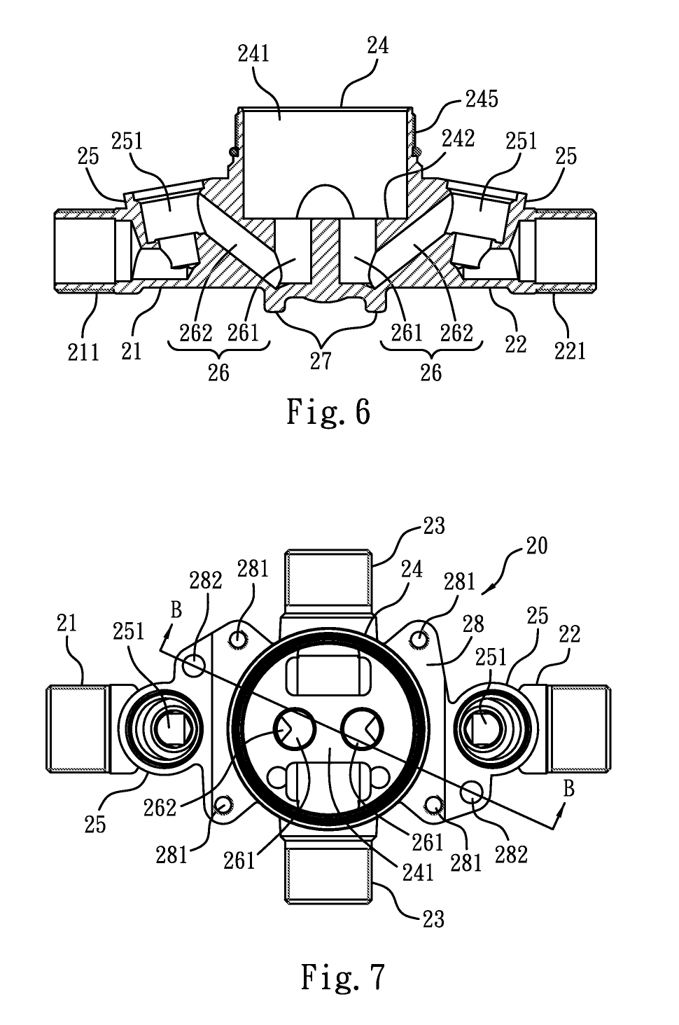

As shown in FIGS. 4, 6 and 11, the temperature control valve seats 24 of the faucet 20 includes a positioning groove 243 defined in an outside thereof and a seal ring 244 is engaged with the positioning groove 243. A sleeve 60 is threadedly mounted to the outer threads 245 of the temperature control valve seats 24 so as to press the temperature control valve 40 on the temperature control valve seats 24. The inside of the sleeve 60 is in contact with the seal ring 244. When water leaks from the top of the temperature control valve 40, the water does not enter into the wall 2 and can be visible on the outside of the wall 2 by the users so that maintenance is proceeded immediately.

The faucet 20 includes at least two pads 27 on an underside thereof so as to contact the surface 3a of the fixing board 3 as shown in FIG. 11. The at least two pads 27 have a height which defines an operation room between the connection portions 211, 221 of the cold and hot water paths 21, 22, the connection portions 231 of the mixing paths 23 and the surface 3a of the fixing board 3. The connection portions 211, 221 of the cold and hot water paths 21, 22 are connected to the cold water pipe and the hot water pipe, and the connection portions 231 of the mixing paths 23 is connected to the outlet path of the faucet. Therefore, once the connection portions 211, 221, 231 leak, the operation room formed by the at least two pads 27 provides the repairers to fix the problem. In this embodiment, a distance “h” is defined between the connection portions 211, 221 and the surface 3a of the fixing board 3. Of course, the number of the pads 27 can be more than two to firmly support the faucet 20 on the surface 3a of the fixing board 3.

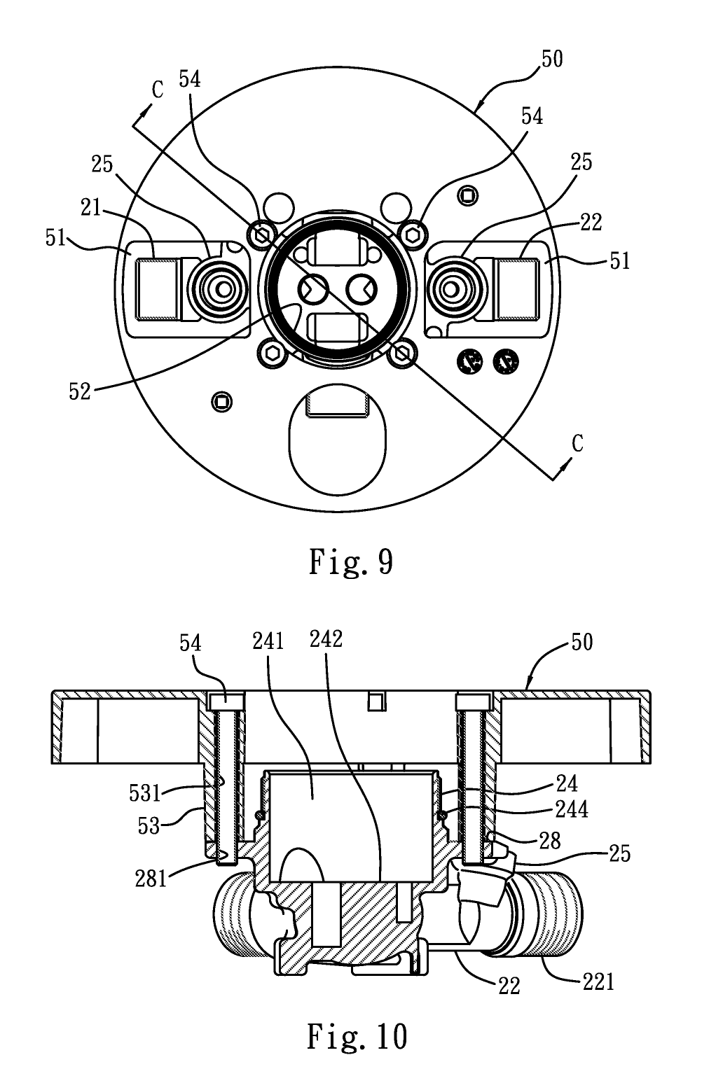

As shown in FIG. 7, an installation flange 28 is located between outside of the faucet 20 and respective tops of the temperature control valve seats 24. The installation flange 28 includes multiple first fixing holes 281 as shown in FIGS. 9 and 10 and multiple support tubes 53 extend from an inner end of the indication board 50. Each support tube 53 has a passage 531 defined therein and multiple bolts 54 each extend through the passage 531 of the support tube 53 and are connected with the first fixing holes 281 to fix the indication board 50 to the installation flange 28. In this embodiment, there are four first fixing holes 281.

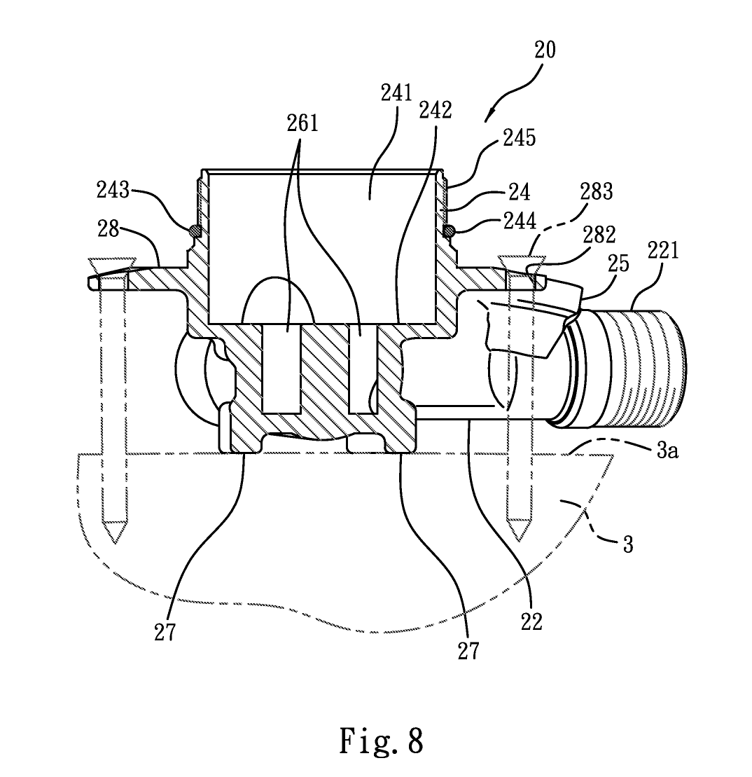

As shown in FIGS. 7 and 8, the installation flange 28 includes multiple second fixing holes 282 and bolts 283 extend through the second fixing holes 282 and are fixed to the fixing board 3 to fix the faucet 20 to the fixing board 3. In this embodiment, there are two second fixing holes 282.

The first and second fixing holes 281, 282 in the installation flange 28 make the connection between the faucet 20 and the fixing board 3, and the connection between the indication board 50 and the faucet 20 easy and convenient. The installation flange 28 is in flush with the tops of the check valve seats 25 so that a sufficient distance is defined between the installation flange 28 and the fixing board 3. Therefore, when changing the indication board 50, especially when the support tubes 53 of the indication board 50 are too short, longer bolts 54 can easily lock the indication board 50 without worry about interference between the distal ends of the bolts 54 and the fixing board 3.

While we have shown and described the embodiment in accordance with the present invention, it should be clear to those skilled in the art that further embodiments may be made without departing from the scope of the present invention.

What is claimed is:

1. A mixer faucet comprising:
a faucet fixed to a fixing board in a wall and having a cold water path, a hot water path, two mixing paths and a temperature control valve seat, the cold and hot water paths each having a check valve seat connected thereto and two check valves are connected to the check valve seats, a temperature control valve connected to the temperature control valve seat, an indication board connected to the faucet and sealing an installation hole in the wall, the indication board having two access holes which are located corresponding to the check valves, a central hole defined through the indication board and the temperature control valve extending through the central hole, wherein
the check valve seats each have a reception recess, the two respective reception recesses are oriented inclinedly and outward, a water inlet is defined between each of the reception recesses and an installation recess of each of the temperature control valve seats, each of the water inlets includes a vertical path and an inclined path, the vertical path extends downward from an inner end of the installation recess of the temperature control valve seats, the inclined path extends inclinedly and downward from an inside of the installation recess of the check valve seat and communicates with the vertical path.

2. The mixer faucet as claimed in claim 1, wherein the temperature control valve seats of the faucet includes a positioning groove defined in an outside thereof and a seal ring is engaged with the positioning groove, a sleeve is threadedly mounted to the temperature control valve seats so as to press the temperature control valve on the temperature control valve seats, an inside of the sleeve is in contact with the seal ring.

3. The mixer faucet as claimed in claim 1, wherein the faucet includes at least two pads on an underside thereof so as to contact the surface of the fixing board, the at least two pads have a height which defines an operation room between the connection portions of the cold and hot water paths, the connection portions of the mixing paths and the surface of the fixing board.

4. The mixer faucet as claimed in claim 1, wherein an installation flange is located between outside of the faucet and respective tops of the temperature control valve seats, the installation flange includes multiple first fixing holes, multiple support tubes extend from an inner end of the indication board and each support tube has a passage defined therein, multiple bolts each extend through the passage of the support tube and are connected with the first fixing holes to fix the indication board to the installation flange.

5. The mixer faucet as claimed in claim 4, wherein the installation flange includes multiple second fixing holes and bolts extend through the second fixing holes and are fixed to the fixing board to fix the faucet to the fixing board.
